(19) United States
(12) Patent Application Publication
(10) Pub. No.: US 2026/0158775 A1
(43) Pub. Date: Jun. 11, 2026

(54) MEANS FOR ASSEMBLY OF PREFABRICATED WALL PANELS

(71) Applicant: Building IP Holdings Pty Ltd, Brisbane (AU)

(72) Inventor: Anthony John HAMMOND, Brisbane (AU)

(73) Assignee: Building IP Holdings Pty Ltd, Brisbane (AU)

(21) Appl. No.: 19/409,829

(22) Filed: Dec. 5, 2025

(30) Foreign Application Priority Data
Dec. 6, 2024 (AU) 2024904041

(51) Int. Cl. B32B 38/18; B32B 37/10; B32B 37/12; B32B 37/18; B65G 13/02

(52) U.S. Cl. CPC B32B 38/1833; B32B 37/10; B32B 37/1284; B32B 37/18; B65G 13/02; B32B 2309/10; B32B 2607/00

(57) ABSTRACT

A system for assembly of prefabricated wall panels from one or more wall sheets and one or more insulation cores, the system comprising a conveyor assembly configured to convey the one or more wall sheets and/or the one or more insulation cores, a handling mechanism for positioning one or more wall sheets and/or the one or more insulation cores and one or more adhesive dispensers configured to dispense an adhesive onto the one or more wall sheets and the one or more insulation cores.

### RELATED APPLICATION(S)

This application claims the benefit of priority of Australia Patent Application No. 2024904041 filed on Dec. 6, 2024, the contents of which are all incorporated by reference as if fully set forth herein in their entirety.

### FIELD AND BACKGROUND OF THE INVENTION

The present invention relates to means for assembly of prefabricated wall panels.

More specifically, the invention relates to a method for assembly of prefabricated wall panels and a system for assembly of prefabricated wall panels.

Prefabricated structural members, such as wall panels, are becoming increasingly more popular and used in the construction industry to create buildings and other structures. The relatively light weight, ease of transport and overall durability of these structural members facilitate the construction of structures in a fast and economically effective manner. Moreover, these structural members provide for an assembly type construction that limits construction/building waste, labour cost, energy requirements, and the like, during construction. Accordingly, these structural members provide easy, sustainable, low-cost construction. Due to these characteristics, prefabricated structural members have been widely used in housing development projects that aim to combat housing shortages.

Another advantage of these prefabricated structural members is that, in general, it decreases the load and reliability on tradespersons during construction. This is a particularly valuable advantage in countries such as Australia, where there is a well-documented shortage in skilled tradespersons.

The advantages and features discussed above have led to a substantial increase in the demand for these prefabricated structural panels. To keep up with the increase in demand, a need has arisen for prefabricated structure providers to increase their production capacity and speed. This has been done by either hiring more personnel to assist with the assembly of prefabricated structure members, or by using machines to at least automate some steps of the process to provide prefabricated structure members that are ready for use.

However, various machines being used in industry lack the necessary care and precision to provide high quality prefabricated members within desired time intervals. This may be due to various factors, such as suboptimal configuration of components, poor factory layout, or the like.

It would therefore be desirable to a method for assembly of prefabricated wall panels and/or a system for assembly of prefabricated wall panels that at least partially overcomes and/or ameliorates the drawbacks of known means for providing prefabricated wall panels or at least provide(s) the public with a useful alternative.

Any references to methods, apparatus or documents of the prior art are not to be taken as constituting any evidence or admission that they formed, or form part of the common general knowledge.

### SUMMARY OF INVENTION

In a first aspect of the invention, there is provided a system for assembly of prefabricated wall panels from one or more wall sheets and one or more insulation cores, the system comprising: a conveyor assembly comprising an assembly surface, which conveyor assembly is configured to convey the one or more wall sheets and/or the one or more insulation cores from a first end of said assembly surface to a second end of the assembly surface; a handling mechanism for positioning one or more wall sheets and/or the one or more insulation cores onto the assembly surface; and one or more adhesive dispensers arranged at a second end of the assembly surface being configured to dispense an adhesive onto the one or more wall sheets and the one or more insulation cores when said wall sheet or insulation core is conveyed in proximity to the one or more adhesive dispensers.

In an embodiment, the conveyor assembly comprises a plurality of rollers forming the assembly surface.

In an embodiment, at least one of the plurality of rollers is actuated to rotate enabling the conveyor assembly to convey the one or more wall sheets and the one or more insulation cores along the assembly surface to and between said first and second end thereof.

In an embodiment, the conveyor surface is arranged inclined such that the one or more wall sheets and the one or more insulation cores placed thereon are conveyed from the first end of said conveyor assembly to said second end under a force of gravity.

In an embodiment, the system further comprises one or more output conveyor surfaces provided in line with, but separate from, the assembly surface, a first end of the one or more output conveyor surfaces arranged adjacent the second end of the assembly surface so as to receive assembled wall panels from said assembly surface.

In an embodiment, further comprising one or more support beds and positioned adjacent the one or more output conveyer surfaces and configured to receive assembled wall panels therefrom, and temporarily store the same.

In an embodiment, which one or more support beds include one or more weight sensors to determine when a temporarily stored plurality of assembled wall panels need to be removed from said one or more support beds.

In an embodiment, the handling mechanism comprises a pneumatic suction gripper provided at the end of a support structure slidingly engaged with a gantry spanning across the assembly surface.

In an embodiment, at least two pneumatic suction grippers are provided, spaced apart to grip the one or more wall sheets and the one or more insulation cores near opposing ends thereof.

In an embodiment, the handling mechanism further comprises an actuator configured to press an end of the handling mechanism to a surface of the one or more wall sheets and the one or more insulation cores.

In an embodiment, the one or more adhesive dispensers comprise a plurality of spray heads spaced apart along the length of a support rod, wherein ends of the support rod are fixed to corresponding ends of components of one or more actuators configured to facilitate vertical movement and adjustment of an angle of the support rod relative to the assembly surface.

In an embodiment, further comprising a catchment tray located below the one or more adhesive dispensers to catch adhesive waste.

In an embodiment, further comprising a controller configured to control the operation of the conveyor assembly, the handling mechanism, and/or the one or more adhesive dispensers.

In an embodiment, further comprising one or more sensors comprising at least one of: an optical distance sensor, a weight sensor, a proximity sensor, a linear position sensor, or an image capturing device.

In an embodiment, the controller is configured to communicate with the one or more sensors to utilise sensor data received therefrom to control said operation of the conveyor assembly, the handling mechanism, and/or the one or more adhesive dispensers.

In an embodiment, the system may further comprise one or more stack beds configured to hold detached wall sheets and insulation cores prior to assembly, the stack beds including guide rods extending upwardly from a base to facilitate alignment of sheets and cores for transfer to the assembly surface.

In an embodiment, the system may include an articulated lifting mechanism or alternative end effector configured to move wall sheets and insulation cores from the stack beds to the assembly surface.

In an embodiment, the handling mechanism may be mounted to a gantry spanning across the assembly surface and driven by a motorized sliding component engaging the gantry.

In an embodiment, the handling mechanism may further comprise a pneumatically driven actuator configured to apply a pressing force to a wall sheet or core during assembly.

In an embodiment, the system may provide multiple suction grippers positioned to reduce mid-span deflection in wall sheets or cores, with the number and placement of grippers selected based on sensor-detected dimensions or weight of the wall sheet or core to be handled.

In an embodiment, the system may include a controller configured to operate locally or through connection to a server computer, the server being located on-site or remote and communicating instructions over a communication network to coordinate assembly operations.

In an embodiment, the system may include sensors positioned to detect thickness, height, position, or alignment of a wall sheet or core and automatically adjust the vertical position and angular orientation of the adhesive dispenser support rod.

In an embodiment, the adhesive dispensing assembly may be supplied by reservoirs or tanks storing constituents of an adhesive mixture, the spray heads being in fluid communication with the reservoirs to deliver metered quantities of adhesive during coating.

In an embodiment, the system may incorporate a catchment tray located below the adhesive dispensers to capture excess adhesive.

In an embodiment, the output conveyor surfaces may be configured as non-powered roller arrays positioned in line with, but separate from, the assembly surface to receive assembled panels and transport them to downstream handling stations.

In an embodiment, the support beds may comprise pallets or modified pallets that enable removal of assembled wall panels by forklift or similar equipment, with weight sensors on the support beds determining when accumulated panels should be removed.

In an embodiment, the assembly surface is inclined by a mechanical device so that wall sheets and cores placed on the rollers travel from the first end to the second end under gravitational force.

In an embodiment, the wall sheets may be provided with peripheral notches configured to admit air between adjacent stacked sheets so as to reduce adhesion between sheets during lifting by the suction grippers.

In an embodiment, the system may comprise a mechanical stopper configured to actuate between an operating state, in which movement along the assembly surface is interrupted or components are temporarily retained, and an idle state, in which the path is cleared for conveyance.

In an embodiment, the mechanical stopper may be relocatable along a guiderail or carried by a mechanical arm to selectively disrupt the assembly path at different locations based on operational sequencing requirements.

In an embodiment, the system may further comprise a second handling mechanism configured to transfer assembled wall panels from the output conveyor surfaces to the support beds.

In a second aspect of the invention, there is provided a method of assembling prefabricated wall panels from one or more wall sheets and one or more insulation cores, the method comprising the steps of: a. conveying a first wall sheet of the one or more wall sheets along an assembly surface of a conveyor assembly from a first end thereof to a second end thereof; b. actuating one or more adhesive dispensers located at the second of the assembly surface to dispense adhesive onto an in-use inner surface of the first wall sheet; c. positioning a first core of the one or more insulation cores upon the in-use inner surface of the first wall sheet; d. actuating the adhesive dispensers to dispense adhesive upon an exposed surface of the first core; e. positioning a second wall sheet of the one or more wall sheets on the exposed surface of the first core by aligning the outer edges of the second wall sheet with outer edges of the underlying first sheet; and f. pressing the second sheet onto the first core to form an assembled wall panel.

In an embodiment, the step of conveying the first wall sheet along the conveyor system comprises conveying the first wall sheet along a roller-based assembly surface.

In an embodiment, the steps of the method are carried out in part by employing at least one powered roller of the roller-based assembly surface to move the first wall sheet, second wall sheet and/or first core about the assembly surface for said positioning, adhesive dispensing and/or pressing.

In an embodiment, the step of positioning the first wall sheet or the first core comprises using a pneumatic suction gripping device provided at the end of a sliding support structure engaged with a gantry spanning across the assembly surface.

In an embodiment, the step of pressing the second sheet onto the core to form an assembled wall panel comprises employing the pneumatic suction gripping device to perform said pressing.

In an embodiment, the step of conveying the first wall sheet along the conveyor system comprises conveying the first wall sheet along a roller-based inclined assembly surface such that the first wall sheet and the core placed thereon are conveyed from the first end to the second end by gravitational force.

In an embodiment, the step of actuating the adhesive dispensers comprises actuating a plurality of spaced-apart spray heads along the length of a support rod to selectively dispense said adhesive and/or actuating at least one end of the support rod to selectively position said spray heads relative the assembly surface.

In an embodiment, further comprising the step of conveying the assembled wall panel from the assembly surface to an output conveyor surface provided in line with, but separate from, the assembly surface, wherein a receiving end of the output conveyor surface is arranged adjacent the second end of the assembly surface.

In an embodiment, further comprising the step of temporarily storing the assembled wall panel on a support bed, detecting when a maximum weight of assembled wall panels have been stored onto said support bed and then removing said assembled wall panels from said support bed.

Any one or more aforementioned embodiments of any one of the first aspect or second aspect may apply equally to the other of the first aspect or second aspect.

### BRIEF DESCRIPTION OF THE SEVERAL VIEWS OF THE DRAWING(S)

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a schematic plan view of an embodiment system for assembly of prefabricated wall panels.

FIG. 2 is a perspective view of an example handling mechanism of the system of FIG. 1.

FIG. 3 is a perspective view of an example conveyer assembly together with the example handling mechanism of the system of FIG. 1.

FIG. 4 is a perspective view of an example adhesive dispenser of the system of FIG. 1.

FIG. 5 is a perspective view of an example output conveyer assembly of the system of FIG. 1.

### DESCRIPTION OF SPECIFIC EMBODIMENTS OF THE INVENTION

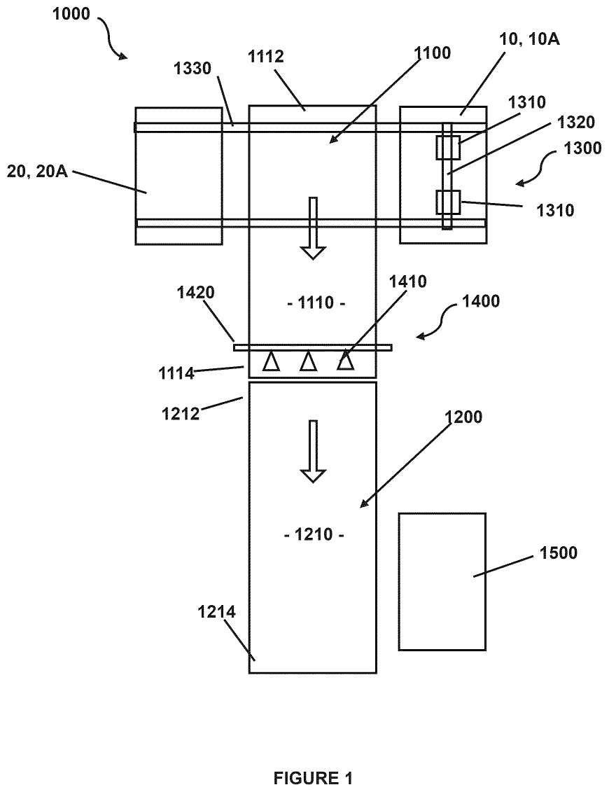

A method and system for assembly of prefabricated wall panels is disclosed. Steps of the method may be performed by a system 1000 as disclosed. The overall system 1000, including its principal subassemblies, is illustrated in FIGS. 1 to 5.

Assembled prefabricated wall panels may include two spaced apart outer wall sheets 10 fixed to an inner insulating core portion 20 positioned between said spaced apart sheets. The insulating core 20 may have one or more channel members fixed to a top, bottom and opposing sides of the core. Each of the channel members are adapted to be interconnected with one or more building elements during construction of a structure.

It should be appreciated that the exact configuration of the assembled prefabricated wall panels is exemplary only and provided to facilitate an understanding of the system 1000 and method described herein. In other words, any discussion elaborating on the configuration of the assembled prefabricated wall panels is provided only as a non-limiting example embodiment of the panels which that aid in the understanding of the invention. The stacked sheets 10, 10A and cores 20, 20A positioned adjacent the system 1000 are shown in FIGS. 1 and 3.

The system 1000 may be provided for assembly of prefabricated wall panels from one or more wall sheets 10 and one or more insulation cores 20. The system 1000 may comprise a conveyor assembly 1100 comprising an assembly surface 1110, which conveyor assembly 1100 is configured to convey the one or more wall sheets 10 and the one or more insulation cores 20 from a first end 1112 of said assembly surface to a second end 1114 of the assembly surface 1110.

The system 1000 may also include a handling mechanism 1300 for positioning one or more wall sheets 10 and the one or more insulation cores 20 onto the assembly surface 1100.

The handling mechanism 1300 may include one or more articulated arms, or other suitable mechanical means, for lifting wall sheets 10 or cores 20 from stack beds 10A, 20A to an assembly surface 1110 of a conveyor assembly 1100. An example handling mechanism 1300 shown in FIGS. 1 to 3.

The system 1000 may also include one or more adhesive dispensers 1400 at a second end 1114 of the assembly surface 1110 being configured to dispense an adhesive onto the one or more wall sheets 10 and the one or more insulation cores 20 when said wall sheet or insulation core is conveyed in proximity to the one or more adhesive dispensers 1400.

In an embodiment, the system 1000 may also include a plurality of stack beds 10A, 20A for stacking one or more elements of a prefabricated wall panel in a detached state that will be used to assemble a wall panel. A first stack bed 10A, for example, may be configured to facilitate stacking of a plurality of wall sheets 10. A second stack bed 20A, for example, may be configured to facilitate stacking of a plurality of insulating cores 20, as shown in FIGS. 1 to 3.

In addition, in some embodiments, the panel system 1000 may include one or more support beds 1500 configured to temporarily store one or more prefabricated wall panels (in an assembled state). The support beds 1500 may be configured to allow for the stacking of assembled wall panels. A support bed 1500 positioned proximate the output conveyor surfaces 1200 is shown schematically in FIG. 1.

Each of the stack beds 10A, 20A, discussed above, may include guides in the form of elongate rods extending upwardly from a base (or frame) of the stack bed 10A, 20A and which is configured to facilitate alignment of the wall sheets 10 and/or cores 20 in a preferred position for operation of the panel system 1000.

The conveyor assembly 1100 may comprise a plurality of rollers 1120 forming the assembly surface 1110. They may be evenly spaced parallel rollers 1120 secured to a frame of the conveyor system 1100.

At least one of the plurality of rollers 1120 may be actuated to rotate enabling the conveyor assembly 1100 to convey the one or more wall sheets 10 and the one or more insulation cores 20 along the assembly surface 1110 to and between said first and second ends 1112, 1114 thereof. In some embodiments, each of the rollers 1120 may be electrically powered to rotate about a central axis thereof using an electrical motor.

In some embodiments, the conveyor surface 1110 may be arranged inclined such that the one or more wall sheets 10 and the one or more insulation cores 20 placed thereon are conveyed from the first end 1112 of said conveyor assembly to said second end 1114 under a force of gravity. In such an embodiment, the rollers 1120 may be passively rotating or free-spinning rollers.

Further, one end of the assembly surface 1110 may be vertically movable using a mechanical device to provide said incline i.e., one end of the assembly surface 1110 may be lifted/angled using a mechanical device, such as a pneumatic motor. Once the end of the assembly surface 1110 has lifted above a horizontal, and therefore to a predetermined angle, any item that is placed on the rollers 1120 may travel along the length (from the lifted end to the other end) of the assembly surface 1110 of the conveyor assembly 1100. The assembly surface 1110, its rollers 1120, and first and second ends 1112, 1114 are shown in FIGS. 3 to 5.

The system 1000, preferably, includes a controller for controlling components of the system. The controller may be any suitable electronic device including a processor and memory for processing data and executing functions of components of the conveyor system. The controller may, for example, be a mobile handset (e.g., a feature phone, a smartphone, tablet computer, etc.), a desktop or laptop computer, a wearable computing device, a smart appliance or other internet-of-things (IoT) device, or the like. In some embodiments the controller may be a built-in, factory computing unit, whereas in other embodiments the controller may be connectable to the conveyor system, for example, via a wired connection.

In some embodiments, the controller may be configured to be in data communication with a server computer. The server computer may be configured to provide instructions to the controller to perform functions of the conveyor system. The server computer may be in data communication with the conveyor system via any suitable communication network, such as the Internet or any other suitable public communication network.

The server may be located at a remote location, however, in a preferred embodiment, the server is located in a warehouse/factory where the system 1000 is normally kept. It should be appreciated that, in some embodiments, the system 1000 may be portable and therefore conduct operations at an off-site location, as and when needed. The server may, for example, be any suitable computing device configured to perform the role of a server such as a server cluster, a distributed server, a cloud-based server or the like.

In a preferred embodiment, the system 1000 includes a handling mechanism 1300 configured to move along a rail/track or gantry 1330 spanning from the first stack bed 10A to the second stack bed 20A, as shown in FIG. 3. The gantry 1330 may be fixed to a frame of the system 1000 vertically offset from the assembly surface 1110 (in other words, the gantry 1330 is fixed to an upper end of a frame of the conveyer 1100 and extends across the assembly surface 1110 from the one stack bed 10A to the other 20A).

In some embodiments, one or more parallel tracks may be provided to facilitate movement of the handling mechanism 1300 across the assembly surface. The handling mechanism 1300 may be configured to grip, lift, move and release one or more wall sheets 10 or cores 20, which ever the case may be, in response to receiving an input to do so.

In one embodiment, the handling mechanism 1300 includes a pneumatic suction gripper 1310 provided at the end of a support structure 1320 slidingly engaged with the gantry 1330 spanning across the assembly surface 1100.

The support structure 1320 may include one or more support beams for securing the suction gripper 1310 and its components thereto. The support beams may be fixed to the gantry 1330 via a sliding component which is configured to facilitate a sliding movement of the support structure 1320 (and the suction gripper(s) 1310) via the gantry 1330.

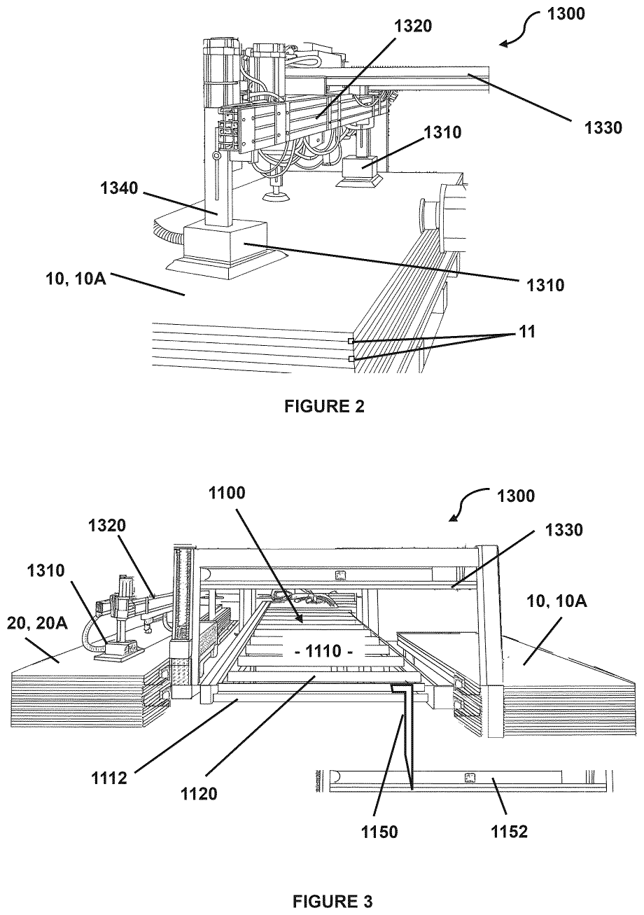

It should be appreciated that the sliding component may be connected to a motor facilitating movement of the sliding component along the gantry 1330. In some embodiments the sliding component may include ball bearings to engage the gantry 1330 and facilitate low friction movement along the gantry 1330. The handling mechanism 1300, suction grippers 1310, support structure 1320, and gantry 1330 are shown in FIGS. 2 and 3 in particular.

It should be appreciated that, any other suitable end effector (as opposed to the pneumatic suction gripper 1310), such as an articulated hand gripper, may be provided as the handling mechanism 1300.

The support structure 1320, gantry 1330 and pneumatic suction gripper(s) 1310 may be controlled by a controller of the conveyor system 1100.

In a preferred embodiment at least two pneumatic suction grippers 1310 are provided, spaced apart to grip the one or more wall sheets 10 and the one or more insulation cores 20 near opposing ends thereof, as shown in FIG. 2.

In some embodiments additional suction grippers may be provided to prevent sagging of heavier sheets or cores at a mid-section thereof. In some embodiments a combination of different end effectors may be used. The spaced grippers 1310 mounted to the support structure 1320 are visible in FIGS. 2 and 3.

In order to prevent adjacent, stacked panels from sticking to one another, due to suction/lack of air between the panels, each wall panel 10 may have one or more notches 11 shown in FIG. 2 near its periphery to allow for air between adjacent panels. In some embodiments, the system 1000 may be configured to make these notches on the panels when stacked. However, in some embodiments, the notches may be made during manufacture of the panels and prior to stacking.

The handling mechanism 1300 may further be configured to apply a pressing force to one or more of the wall sheets 10 or the core 20 as and when required. As such, the handling mechanism, in some embodiments, may be configured to grip and lift the relevant element via a suction power and, once the element is located appropriately, release the element and press against the element. The handling mechanism may therefore include an actuator 1340 (such as a pneumatic actuator) for pressing an end of the handling mechanism, such as a suction head, to a surface of the appropriate wall sheet or core. The actuator 1340 associated with the handling mechanism is depicted in FIG. 2.

In some embodiments, a separate, independent pneumatically controlled pressing device, such as a linear pneumatic, electric or hydraulic actuator or ram, or otherwise, may be provided that is configured to press against a wall sheet 10 or core 20 when needed.

The system 1000 may further comprise one or more sensors comprising at least one of: an optical distance sensor, a weight sensor, a proximity sensor, a linear position sensor, or an image capturing device. The controller may be configured to communicate with the one or more sensors to utilise sensor data received therefrom to control said operation of the conveyor assembly 1100, the handling mechanism 1300 and/or the one or more adhesive dispensers 1400. A plurality of sensors provided at/fixed to various locations of the system 1000 may be envisaged.

In some embodiments, the system 1000 may include one or more sensors to determine the dimensions and/or weight of a wall panel 10 in the panel stack 10A and, based on the dimensions and/or weight of the panel determine the number of pneumatic suction grippers 1310 and/or the positioning thereof that may be required to lift the wall panel 10. It should be understood that the controller may enable processing of the sensor data to generate the desired instructions to other components of the system 1000.

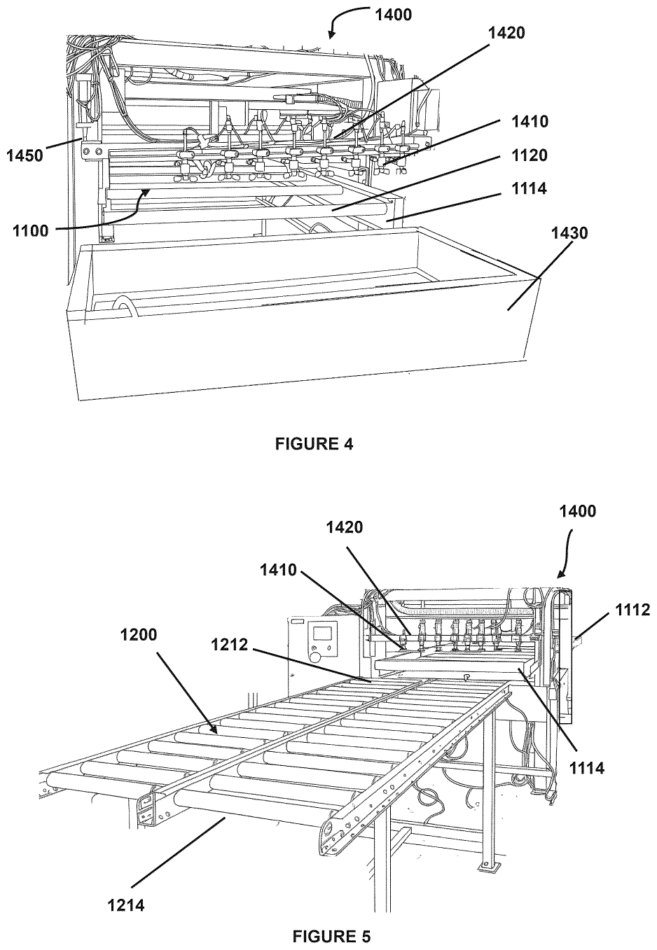

As shown in FIGS. 4 and 5, the system 1000 may further include one or more adhesive dispensers 1400, provided on the frame of the system 1000 and disposed above a far end 1114 of the assembly surface 1110 of the conveyor system.

The adhesive dispensers 1400 may be configured to dispense an adhesive mixture onto one or both of a wall sheet 10 or an insulating core 20 in a method for assembling a wall panel. Accordingly, the purpose of the adhesive mixture is to facilitate bonding of wall sheets to the core. In a preferred embodiment the adhesive used for the bonding is a fast setting glue mixture.

The adhesive dispensers 1400 may be one or more spray heads 1410 spaced apart along the length of a support rod 1420, shown in FIG. 2. Preferably a plurality of adhesive dispensers 1400 is provided.

In the present embodiment, ends of the support rod 1420 may be fixed to corresponding ends of components of one or more actuators 1450 configured so as to facilitate vertical movement and adjustment of an angle of the support rod 1420 relative to the assembly surface 1110.

Preferably, the actuators 1450 are independently operated so as to facilitate movement of one end of the rod 1420 while the other end remains in position or moves in another direction. In a preferred embodiment, the actuator 1450 is a pneumatic cylinder in fluid communication with a compressor. Preferably, two pneumatic cylinders are provided and each of the ends of the dispensing component support rod 1420 are fixed to a corresponding piston rod of the adjacent pneumatic cylinder. The spray heads 1410, support rod 1420 and actuator 1450 arrangement is illustrated in FIG. 4, where only one actuator 1450 is visible at one end of the support rod 1420.

The adhesive dispensers 1400 and at least one of the actuators 1450 may be controlled by the controller of the conveyor system 1100 in response to an input being received by the controller. Accordingly, in some embodiments, only one of the actuators 1450 may be controlled and therefore only one end of the support rod 1420 may be moved relative to the assembly surface 1110.

As previously mentioned, the system 1000 may include one or more sensors provided/fixed at various locations of the system 1000. Each of the one or more sensors may be able to capture data (as they are pre-configured to do) and relay the data to the controller as part of a feedback loop. The controller may receive the data, process the data, and take action (or cause action to be taken) based on the processed data.

The action being taken by the controller may be to instruct one or more of the components in communication (electrical or network, or both) with the controller to perform a desired action. For example, in some embodiments the system may be configured to provide for additional components or equipment to be added to the system, without requiring substantial (or any) rewiring.

In such embodiments, the controller may be configured to wirelessly communicate with said added components and instruct such components to perform the required actions based on data received from the one or more sensors.

Accordingly, in some embodiments, one or more sensors may be provided to assist with operation of the dispensing components 1400 and the relevant actuator/s 1450. For example, the sensors may be configured to determine the thickness (or at least the highest point) at one or more detection points of the core 20 or panel 10 on the assembly surface 1110 and cause the actuators 1450 to angle the spray heads 1410 accordingly.

For example, one end of the support rod 1420, to which the spray heads 1410 are fixed, may need to be lower than the other end. In addition to the above, it should be appreciated that wall sheets 10 and/or insulating cores 20 of various dimensions and other characteristics may be provided.

As such, one or more sensors may be used to identify/determine the number of dispensing spray heads 1410 that need to be activated at a given time. For example, a narrow wall sheet or core may require fewer spray heads 1410 to dispense an adhesive, compared to the spray heads 1410 required for a wide wall sheet or core.

Each of the one or more spray heads 1410 may be in fluid communication with an adhesive mixture supply. In some embodiments, this may include the dispensing spray heads 1410 being in fluid communication with one or more reservoirs, tanks, or the like, storing elements of the adhesive.

As discussed above, the adhesive dispensers 1400 may be provided at/near a far end 1114 of the assembly surface 1110. As such, in order to prevent waste of the adhesive, a catchment tray 1430 shown in FIG. 4 may be provided with at least a portion of the catchment tray 1430 being located below the dispensing components 1400 (at a vertically offset position) to catch any adhesive waste. This may limit waste and enable less burdensome cleaning operation.

In addition to the conveyor assembly 1100, the system 1000 includes one or more output conveyor surfaces 1200, as shown in FIGS. 1 and 5. The one or more output conveyor surfaces 1200 are separate, independent conveyor surfaces provided in line with, but separate from, the assembly surface 1110, with a first end 1212 arranged adjacent the second end 1114 of the assembly surface 1110 so as to receive components therefrom, and a second end 1214 to facilitate unloading.

Each of the one or more output conveyor surfaces 1200 may have a similar configuration to that of the assembly surface 1110 and be configured to receive panels, cores, or a combination thereof, from the assembly surface. In some embodiments, the output conveyor surfaces 1200 may comprise rollers as shown to facilitate low friction movement of the assembled panel. As such, the rollers need not be mechanically/electrically operated.

In a preferred embodiment, the output conveyor surfaces 1200 are used to transport assembled wall panels (including the wall sheets 10 bonded to the core 20) to the one or more support beds 1500 configured to temporarily store the one or more prefabricated wall panels. As such, ideally, the output conveyor surfaces 1200 should terminate in close proximity to the support beds 1500, as shown in FIG. 1, so as to facilitate fast and easy unloading/removal of the assembled wall panels from the surfaces to the support beds 1500. The support beds may be similarly configured to the stack beds 10A, 20A. The spatial relationship of the output conveyor 1200 and support bed 1500 is shown in FIG. 1.

In a preferred embodiment, the support beds 1500 may include one or more weight sensors to determine when panels need to be removed from the support beds. The timing of when the panels need to be removed may be dependent on the needs of a particular project, weight considerations for transport, or the like. In a preferred embodiment, the support beds 1500 are one or more pallets (or modified pallets) facilitating easy removal of the assembled wall panels via a forklift, or any other suitable machinery.

In some embodiments, the assembly surface 1110 may have a mechanical stopper 1150 configured to actuate between an operating state and an idle state. In the operating state, the stopper 1150 may be configured to at least partially disrupt a path provided by the assembly surface 1110, as shown in FIG. 3.

In some embodiments, the mechanical stopper may be configured such that, in the operating state, it removably attaches to one or more components being conveyed on the assembly surface 1110.

In the idle state, the mechanical stopper 1150 returns to its original position so as to clear the path provided by the assembly surface. The stopper 1150 may be electrically operated. In some embodiments, the stopper 1150 may be configured to move in one or more directions so as to enable the stopper 1150 to disrupt the path at different locations along the assembly surface 1110. In such embodiments, the stopper 1150 may be configured to move along a guiderail 1152 shown exemplarily in FIG. 3, or be an end effector of a mechanical arm, configured to guide/move the stopper into a desired location and move the stopper from the idle to the operating state.

An example method of assembling prefabricated wall panels from one or more wall sheets 10 and one or more insulation cores 20 may be envisaged. The embodiment system 1000 of FIGS. 1 to 5 may facilitate such a method and/or the method may be carried out by other means.

The example method may comprise the steps of: conveying a first wall sheet 10 of the one or more wall sheets along an assembly surface 1110 of a conveyor assembly 1100 from a first end 1112 thereof to a second end 1114 thereof.

The method may then include actuating one or more adhesive dispensers 1400 located at the second end 1114 of the assembly surface 1110 to dispense adhesive onto an in-use inner surface of the first wall sheet 10, and then positioning a first core 20 of the one or more insulation cores upon the in-use inner surface of the first wall sheet 10.

The method may then include actuating the adhesive dispensers 1400 to dispense adhesive upon an exposed surface of the first core 20, positioning a second wall sheet 10 of the one or more wall sheets on the exposed surface of the first core 20 by aligning the outer edges of the second wall sheet 10 with outer edges of the underlying first sheet 10, and pressing the second sheet 10 onto the first core 20 to form an assembled wall panel.

The step of conveying the first wall sheet 10 along the conveyor system 1100 may comprise conveying the first wall sheet 10 along a roller-based assembly surface 1110.

The aforementioned steps of the method may be carried out in part by employing at least one powered roller 1120 of the roller-based assembly surface 1110 to move the first wall sheet 10, second wall sheet 10 and/or first core 20 about the assembly surface 1110 for said positioning, adhesive dispensing and/or pressing.

The method may then include the step of positioning the first wall sheet 10 or the first core 20 comprises using a pneumatic suction gripping device 1310 provided at the end of a sliding support structure 1320 engaged with a gantry 1330 spanning across the assembly surface 1110.

The step of pressing the second sheet 10 onto the core 20 to form an assembled wall panel may comprise employing the pneumatic suction gripping device 1310 to perform said pressing.

The step of conveying the first wall sheet 10 along the conveyor system 1100 may include conveying the first wall sheet 10 along a roller-based inclined assembly surface 1110 such that the first wall sheet 10 and the core 20 placed thereon are conveyed from the first end 1112 to the second end 1114 by gravitational force.

Moreover, the step of actuating the adhesive dispensers 1400 may include actuating a plurality of spaced-apart spray heads 1410 along the length of a support rod 1420 to selectively dispense said adhesive and/or actuating at least one end of the support rod 1420 to selectively position said spray heads 1410 relative the assembly surface 1110.

The method may then include the step of conveying the assembled wall panel from the assembly surface 1110 to an output conveyor surface 1200 provided in line with, but separate from, the assembly surface 1110, wherein a receiving end 1212 of the output conveyor surface 1200 is arranged adjacent the second end 1114 of the assembly surface 1110.

Moreover, the method may then include the step of temporarily storing the assembled wall panel on a support bed 1500, detecting when a maximum weight of assembled wall panels have been stored onto said support bed 1500 and then removing said assembled wall panels from said support bed 1500.

In the present case, said wall sheets 10 and cores 20 may have already been manufactured, and assembly of the final wall panels by way of the aforementioned method are simply required. The wall sheets 10 and cores 20 may be stacked on the stacking beds 10A, 20A and moved into position by one or more users via factory machinery or manually, for example.

The method may be performed by a user providing input to a use interface of a controller of the embodiment system 1000 or any other suitable system, for example. The input may comprise preparing a panel of a predetermined size (normally selected from industry standard sizes).

In response to receiving the user input, the handling mechanism 1300 may be located above an appropriate stack bed 10A, 20A and grip a wall sheet 10 and place the wall sheet 10 on the assembly surface 1110. The wall sheet 10 may be moved to the one or more adhesive dispensers 1400, via the rotating rollers 1120 of the assembly surface 1110, where the wall sheet 10 is at least partially coated with the adhesive.

The pattern with which the wall sheet 10 is coated with the adhesive may depend on sensor data captured by one or more sensors of the embodiment system 1000 and processed by the controller thereof, for example.

Once a coat of adhesive has been applied, the wall sheet 10 may be returned to a desired location along the length of the assembly surface 1110 via one or more actuated rotating rollers 1120.

At the same time, (or at a preferred interval) the handling mechanism 1300 may have been moved (via the gantry 1330) to the other stack bed 20A and operated to grip and hold a core 20. Once the coated wall sheet 10 has been moved to the desired location, the core 20 may be appropriately located (relevant to the coated wall sheet 10), released and pressed onto the wall sheet 10 via the handling mechanism 1300. The handling mechanism 1300 may be configured to press against a surface of the core 20 to facilitate bonding of the core 20 and the wall sheet 10.

Similar steps may then be performed to move the semi-assembled wall panel to the adhesive dispensers 1400. Once in position, the dispensers 1400 may be activated and at least partially coat the exposed surface of the core 20 with the adhesive. To facilitate even dispensing along the surface of the core 20, the assembly surface 1110 may be controlled to move the core 20, by way of said one or more actuated rotating rollers 1120 as needed.

The semi-assembled wall panel may then be returned to its original position. Using similar steps (to the steps used to pick-up and place the core 20 on the wall sheet 10), a second wall sheet 10 may be placed onto and pressed against the adhesive coated exposed surface of the core 20. The assembly surface 1110 may then be configured to move the assembled wall panel from the assembly surface 1110 and onto the one or more output conveyor surfaces 1200. The assembled wall panel may then manually removed from the one or more output conveyor surfaces 1200 and placed on the relevant support bed 1500.

In some embodiments, a second or further handling mechanism may be provided to move assembled wall panels from the one or more output conveyor surfaces 1200 onto a support bed 1500. Such a second or further handling mechanism may be configured similarly or identically to the handling mechanism 1300 previously described.

These steps of the example method may be repeated in order to assemble more panels.

Any of the steps, operations, components or processes described herein may be performed or implemented with one or more hardware or software units, alone or in combination with other devices. Components or devices configured or arranged to perform described functions or operations may be so arranged or configured through computer-implemented instructions which implement or carry out the described functions, algorithms, or methods.

The computer-implemented instructions may be provided by hardware or software units. In one embodiment, a software unit is implemented with a computer program product comprising a non-transient or non-transitory computer-readable medium containing computer program code, which can be executed by a processor for performing any or all of the steps, operations, or processes described. Software units or functions described in this application may be implemented as computer program code using any suitable computer language such as, for example, Java™ C++, or Perl™ using, for example, conventional or object-oriented techniques.

The computer program code may be stored as a series of instructions, or commands on a non-transitory computer-readable medium, such as a random-access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

### LIST OF REFERENCE NUMERALS

System for assembly of prefabricated wall panels 1000
   Wall sheets 10
   Insulation cores 20
Support beds 1500
Conveyor assembly 1100
   Assembly surface 1110
   Plurality of rollers 1120
      First end of said assembly surface 1112
      Second end of the assembly surface 1114
   Output conveyor surfaces 1200
      First end of the output conveyor surface 1212
      First end of the output conveyor surface 1214
Handling mechanism 1300
   Pneumatic suction gripper 1310
   Support structure 1320
   Gantry 1330
   Actuator 1340
One or more adhesive dispensers 1400
   Plurality of spray heads 1410
   Support rod 1420
   Catchment tray 1430
   Actuator 1450

What is claimed is:

1. A system for assembly of prefabricated wall panels from one or more wall sheets and one or more insulation cores, the system comprising:
a conveyor assembly comprising an assembly surface, which conveyor assembly is configured to convey the one or more wall sheets and/or the one or more insulation cores from a first end of said assembly surface to a second end of the assembly surface;
a handling mechanism for positioning one or more wall sheets and/or the one or more insulation cores onto the assembly surface; and
one or more adhesive dispensers arranged at a second end of the assembly surface being configured to dispense an adhesive onto the one or more wall sheets and the one or more insulation cores when said wall sheet or insulation core is conveyed in proximity to the one or more adhesive dispensers.

2. The system of claim 1, wherein the conveyor assembly comprises a plurality of rollers forming the assembly surface.

3. The system of claim 2, wherein at least one of the plurality of rollers is actuated to rotate enabling the conveyor assembly to convey the one or more wall sheets and the one or more insulation cores along the assembly surface to and between said first and second end thereof.

4. The system of claim 1, wherein the conveyor surface is arranged inclined such that the one or more wall sheets and the one or more insulation cores placed thereon are conveyed from the first end of said conveyor assembly to said second end under a force of gravity.

5. The system of claim 1, wherein the handling mechanism comprises a pneumatic suction gripper provided at the end of a support structure slidingly engaged with a gantry spanning across the assembly surface.

6. The system of claim 5, wherein at least two pneumatic suction grippers are provided, spaced apart to grip the one or more wall sheets and the one or more insulation cores near opposing ends thereof.

7. The system of claim 1, wherein the handling mechanism further comprises an actuator configured to press an end of the handling mechanism to a surface of the one or more wall sheets and the one or more insulation cores.

8. The system of claim 1, wherein the one or more adhesive dispensers comprise a plurality of spray heads spaced apart along the length of a support rod, wherein ends of the support rod are fixed to corresponding ends of components of one or more actuators configured to facilitate vertical movement and adjustment of an angle of the support rod relative to the assembly surface.

9. The system of claim 1, wherein the system further comprises one or more output conveyor surfaces provided in line with, but separate from, the assembly surface, a first end of the one or more output conveyor surfaces arranged adjacent the second end of the assembly surface so as to receive assembled wall panels from said assembly surface.

10. The system of claim 9, further comprising one or more support beds and positioned adjacent the one or more output conveyer surfaces and configured to receive assembled wall panels therefrom, and temporarily store the same, which one or more support beds include one or more weight sensors to determine when a temporarily stored plurality of assembled wall panels need to be removed from said one or more support beds.

11. The system of claim 1, further comprising a controller configured to control the operation of the conveyor assembly, the handling mechanism, and/or the one or more adhesive dispensers.

12. The system of claim 11, further comprising one or more sensors comprising at least one of: an optical distance sensor, a weight sensor, a proximity sensor, a linear position sensor, or an image capturing device.

13. The system of claim 12, wherein the controller is configured to communicate with the one or more sensors to utilise sensor data received therefrom to control said operation of the conveyor assembly, the handling mechanism, and/or the one or more adhesive dispensers.

14. A method of assembling prefabricated wall panels from one or more wall sheets and one or more insulation cores, the method comprising the steps of:
a. conveying a first wall sheet of the one or more wall sheets along an assembly surface of a conveyor assembly from a first end thereof to a second end thereof;
b. actuating one or more adhesive dispensers located at the second of the assembly surface to dispense adhesive onto an in-use inner surface of the first wall sheet;
c. positioning a first core of the one or more insulation cores upon the in-use inner surface of the first wall sheet;
d. actuating the adhesive dispensers to dispense adhesive upon an exposed surface of the first core;
e. positioning a second wall sheet of the one or more wall sheets on the exposed surface of the first core by aligning the outer edges of the second wall sheet with outer edges of the underlying first sheet; and
f. pressing the second sheet onto the first core to form an assembled wall panel.

15. The method of claim 14, wherein the step of conveying the first wall sheet along the conveyor system comprises conveying the first wall sheet along a roller-based assembly surface.

16. The method of claim 14, wherein the steps of the method are carried out in part by employing at least one powered roller of the roller-based assembly surface to move the first wall sheet, second wall sheet and/or first core about the assembly surface for said positioning, adhesive dispensing and/or pressing.

17. The method of claim 14, wherein the step of positioning the first wall sheet or the first core comprises using a pneumatic suction gripping device provided at the end of a sliding support structure engaged with a gantry spanning across the assembly surface.

18. The method of claim 17, wherein the step of pressing the second sheet onto the core to form an assembled wall panel comprises employing the pneumatic suction gripping device to perform said pressing.

19. The method of claim 14, wherein the step of conveying the first wall sheet along the conveyor system comprises conveying the first wall sheet along a roller-based inclined assembly surface such that the first wall sheet and the core placed thereon are conveyed from the first end to the second end by gravitational force.

20. The method of claim 14, wherein the step of actuating the adhesive dispensers comprises actuating a plurality of spaced-apart spray heads along the length of a support rod to selectively dispense said adhesive and/or actuating at least one end of the support rod to selectively position said spray heads relative the assembly surface.
